(19) United States
(12) Patent Application Publication
(10) Pub. No.: US 2002/0038265 A1
(43) Pub. Date: Mar. 28, 2002

(54) System and method for management of pooled fungible items

(75) Inventors: Herbert Mertz, Princeton, NJ (US); Bradford Hugh Bruce, Lawrence, NJ (US)

Correspondence Address: PENNIE AND EDMONDS, 1155 AVENUE OF THE AMERICAS, NEW YORK, NY, 100362711

(73) Assignee: Interpool Limited

(21) Appl. No.: 09/801,591

(22) Filed: Mar. 8, 2001

Related U.S. Application Data
(63) Continuation of application No. 09/127,180, filed on Jul. 31, 1998, now abandoned.

(51) Int. Cl. G06F 17/60

(52) U.S. Cl. 705/28

(57) ABSTRACT

A system and method for managing pools of fungible items, for example, a cooperative pool of cargo container chassis formed by more than one participating shipping company. The system and method provides a software and hardware environment which allows convenient electronic data interchange (“EDI”) to and from users who may be using a variety of EDI modalities. The system provides for analysis of data pertaining to chassis pool operation, chassis maintenance and repair, and pool administration. Rather than simply reporting tabulated data, the system and method performs trend analyses, and an imbedded expert system provides suggestions regarding actions to be taken to enhance pool efficiency. The system and method provides for automated execution of routine analyses, and also allows users to easily design and save their own custom analyses.

### FIELD OF THE INVENTION

The field of this invention relates generally to a computerized system and method of managing pooled fungible items. More particularly, the invention pertains to the management of cargo shipping container chassis (“chassis”) pools.

### BACKGROUND

Cargo Container Chassis

The standard cargo container is a steel box, 8 feet wide, 8½% feet high, and either 20 or 40 feet long. In the last half of the 20th century, the intermodal container—a box that is compatible with rail, marine, and truck transportation—has had a major influence on international trade and shipping.

There are millions of containers currently in use around the world, and those containers carry an astonishing variety of cargo, including agricultural products, consumer electronics, automotive parts, clothing, and highly toxic chemicals. “Containerization” is becoming the shipping mode of choice going into the twenty-first century because consolidating and packing cargo in containers dramatically increases the cargo's portability and the handlers' efficiency. Containerization reduces pilferage, accidental loss, and weather damage to cargo, and generally simplifies the complicated task of moving products around the world.

Containers are generally freely interchangeable between modes of transport, making it possible to move cargo from a point of origin to a final destination without the repeated unpacking and repacking of the goods required by traditional shipping methods. The same containers may be carried successively on a ship, railcar and truck and across international borders with minimal customs formalities. Containers may also be picked up, dropped off, stored and repaired at common user depots or “pool points” located throughout the world, usually in port areas or near railheads.

When a container vessel arrives in port, each container is loaded onto a chassis or railcar. A chassis is a rectangular, wheeled steel frame, generally 20 or 40 feet in length, built specifically for the purpose of transporting a container. Once mounted, the container and chassis are the functional equivalent of a trailer. When mounted on a chassis, the container may be trucked either to its final destination or to a railroad station for loading onto a railcar. Similarly, a container shipped by rail may be transferred to a chassis to travel over the road to its final destination. Chassis, like containers, may be picked up, dropped off, stored and repaired at depots and pool points.

Attendant to the many benefits of containerization, there are problems associated with the growth of this shipping method. As the container business expands, it is becoming financially burdensome for the shipping lines to own or lease all of the containers and chassis which they need to operate. As a result, it is becoming increasingly common for shipping companies to group together to form container and chassis pools.

Cooperative Chassis Pooling

By pooling their chassis fleets, shipping companies or lines can share resources, and meet periods of individual heavy demand with fewer total chassis, a practice known in the industry as “load leveling”. Clearly, chassis pools are beneficial from the standpoint of asset utilization. Some numbers can be posited to demonstrate the savings available through pooling. A typical chassis pool may have 14,000 chassis. Assume that chassis ownership cost is $5.00/day (composed of amortized purchase price, licensing, insurance, and maintenance and repair), and that the sharing of chassis through pooling will allow participating shippers (“participants”) to reduce their chassis fleet by 20%. The total fleet reduction is (20% of 14,000 chassis) or 2,800 chassis. The annual savings due to pooling in this example is (2,800 chassis saved×$5.00 per chassis/day×365 days/year) or $5.11 Million. This savings is shared pro rata among the participants in proportion to the number of chassis contributed by each, inasmuch as each is able to reduce the size of its fleet proportionately.

In a typical chassis pool arrangement, the various participants each contribute some number of chassis to the pool. The number of chassis contributed by each participant defines its contribution to the pool. The participants share the pool chassis subject to certain contribution and utilization requirements. The pool is administered by a chassis pool management company. The pool manager keeps track of the chassis taken and used from the pool by each participant. The pool chassis may also be leased to non-participant users, at a daily, “per diem” rate. The pool manager's most basic function is to keep track of chassis utilization, so as to ensure that the load leveling potential of the pool is in fact being realized.

In addition to the cost savings to the pool participants based on reduced fleet size, pooling can also benefit members by reducing maintenance and repair (“M&R”) costs. These cost savings are realized through better management oversight and less damage to equipment due to tighter controls. Supervision of the M&R function and billing for M&R expenses is another important responsibility of the pool manager.

Other functions of the pool manager include: forecasting of chassis surpluses and deficits, forecasting inventory imbalances at different pool locations, and preventing potential imbalances by repositioning chassis based upon trend analysis.

Chassis Pool Management

Even when chassis fleets are pooled, efficiency is still a paramount concern. If the size of the pooled chassis inventory is not properly controlled, all the benefits of pooling can be lost. In such a case, the participants could end up losing money by pooling, due to administrative costs associated with pool administration. Furthermore, idle chassis are not revenue producing, and take up valuable space in intermodal terminals (marine port areas, railroad yards, truck yards) which is needed for cargo-bearing chassis.

Therefore it is important that the pool manager be able to obtain accurate and timely information regarding efficiency of the pool operation. It is also important for the pool manager to be able to provide this information, in easily comprehensible format, to the pool participants. Typical information which can be used to evaluate pool efficiency includes: unit availability, unit utilization, idle units, missing units, unit free days, unit turn time, and trips per unit per month. In its most basic form, this information is simply tabular numeric data for the relevant parameters. However, in order to make the evaluation of pool efficiency more effective, it is desirable to include forecasting and analysis functions, performed by an artificial intelligence or expert system. Access to such analysis by pool participants will allow them to adjust shipment schedules as required, or if necessary, to adjust the level of their participation in (i.e., the number of chassis contributed to) the pool.

Therefore there exists in the industry a need for a chassis pool management system which provides the end users with an artificial intelligence-based system which will analyze pool performance, recommend actions to alleviate problems and/or prevent potential problems, and which allows the end users to quickly and easily perform timely and accurate analyses regarding various efficiency parameters of the pool.

In addition to providing the end users with analyses based on the raw data regarding the pool operations, it is desirable to also provide them with automatic warnings regarding actual or potential problems or inefficiencies. Even further, it is desired to provide a pool management expert system providing artificial intelligence (“AI”) based suggestions for actions to be taken to alleviate or prevent such undesirable occurrences.

Furthermore, despite their overall benefits, certain unique problems are introduced by the pooling of hassis. For example, it is typical in operating a chassis pool that each participant has a target number of chassis which it is expected to contribute to the pool. In order for the pool to operate fairly, contribution levels should not drop below the target levels. Furthermore, typical arrangements also establish a minimum contribution level that each participant must satisfy at all times, or risk losing membership in the pool. Also, pooling arrangements typically provide for fines to be paid by participants who do in fact allow their contribution levels to dip below target levels. Therefore, there exists a need in the industry for a chassis pool management system which warns participants if their contribution is threatening to fall below the predetermined target or minimum levels.

In order to provide timely warnings and to assess appropriate fines, it is important that the pool manager have timely and accurate data regarding contribution levels by participant. Furthermore, the manager must be able to compare the actual contribution and utilization data against budgeted levels. Therefore, there exists a need in the industry for a chassis pool management system which allows the pool manager to quickly and easily obtain timely and accurate information regarding contribution and utilization levels of all participating companies.

Furthermore, pooling arrangements may also provide for excess use penalties to be paid by participants when their level of chassis utilization exceeds a predetermined amount. Utilization by an individual shipper for a given period is determined by dividing the number of days of actual use (“Usage Days”) by the number of chassis contributed by that shipper (“Contrib. Chassis”) multiplied by number of days the chassis were in the pool during the period (“Contrib. Days”):

$$Utilization = \frac{( Usage Days )}{( Contrib . Chassis ) \times ( Contrib . Days )}$$

For example, a pooling arrangement may provide that a participant be assessed a penalty of $5.00 per utilized chassis per day for participants exceeding 110% utilization for a specified period of time.

Maintenance and Repair (“M&R”) Administration

Due to the heavy use of container chassis, frequent maintenance and repair (“M&R”) is required to keep chassis operable and to satisfy regulatory requirements established, for example, by the Department of Transportation (“DOT”). The administrative requirements associated with forecasting, tracking, and paying for M&R expenses can be unduly burdensome on shipping companies. These administrative problems are only exacerbated when chassis are pooled. Therefore there exists a need in the industry for a way to simplify the administrative requirements associated with the M&R aspects of chassis ownership and chassis pools, and to provide timely and accurate analyses to the participating shippers regarding M&R issues.

Known Spreadsheet-based Pool Management Systems

Some efforts have previously been made to automate chassis pool management in order to increase efficiency. However, these known systems are typically based on simple spreadsheet applications and do not provide the flexibility of data handling, artificial intelligence-based analysis, and presentation of results that is offered by the chassis pool management system described herein. In spreadsheet-based systems, reports must be manually transmitted, for example by telefacsimile, by personnel at the chassis pool management office to the end user. Therefore, there exists a need in the industry for a chassis pool management system that provides automated scheduling of analysis performance and distribution of the analysis results.

Users of spreadsheet based systems must submit proposed report layouts to the pool manager's information services staff. The staff will then develop the report, either from scratch or modifying an existing report template. Therefore, there exists a need in the industry for a chassis pool management system that permits end-users to design their own analyses and reports using an on-line report designer subroutine.

### SUMMARY OF THE INVENTION

Accordingly, the present invention comprises a system and method for management of pooled fungible items. Although the discussion herein in directed to a preferred embodiment as applied to a chassis pool, it will be evident that the invention may be applied, with obvious modifications, to pools of other fungible items. This system allows the pool manager to perform the administrative function more efficiently and accurately than using known pool management techniques.

The present invention further provides an expert system for rule-based analysis of pool data, to automatically recognize the existence of problems with pool operations (diagnosis function), to infer likely future problems (prediction function), generate warnings regarding actual or potential problems with pool operations, and to suggest action to be taken to alleviate or prevent such problems (remedy function).

In accordance with this invention, a computer-based data analysis system for managing a pool of fungible items includes a database server means for processing pool data; storage means communicating with the database server means for storing pool data; one or more user terminals for access to the database server by system users; and an application server for communicating between the user terminals and the database server. The system also includes first means for specifying an analysis of pool data to be performed and second means, responsive to the first means, for performing analyses of pool data according to the criteria of the selected analysis. The analyses performed by the second means are based on pool performance data, maintenance and repair data, and pool administration data.

The first means may comprise means for selecting the analysis to be performed from among a list of pre-defined analyses, or means for creating an analysis by selecting or entering the appropriate value for each relevant parameter from among a list of available parameters regarding pool operations, such that the pool analysis performed according to the selected or entered parameters will provide an analysis of the desired aspects of pool operations. The second means may utilize an expert system, applying pre-defined rules to provide diagnostic comments regarding pool data.

Also in accordance with the invention, a computer-based data analysis system for managing a pool comprises: database server means for processing pool data; storage means communicating with the database server means for storing pool data; one or more user terminals for access to the database server by users of the system; and application server means for communicating between the user terminals and the database server. The system further comprises first means for specifying an analysis to be performed; and second means, responsive to the first means, for performing analyses of pool data according to the criteria of the selected analysis. The analyses performed by the second means are based on pool performance data, maintenance and repair data, and pool administration data.

The first means may comprise means for selecting the analysis to be performed from among a list of pre-defined analyses and/or means for creating an analysis by selecting or entering the appropriate value for each parameter from among a list of available parameters regarding pool operations, such that the pool analysis performed according to the selected or entered parameters will provide an analysis of the desired aspects of pool operations. The second means comprises an expert system applying pre-defined rules to provide diagnostic comments regarding pool data.

Also in accordance with the invention, a pool management system performs analyses of pool performance data. These analyses comprise one or more of the following: inventory status, unit activity and history, units idle over x days (where x is a user-selectable value), units out over x days, units currently out of service, budgeted versus actual utilization summary, budgeted versus actual utilization daily, actual daily utilization, imbalance, turn time, and trips per unit per month. The pool management system also performs analyses of maintenance and repair data. These analyses comprise one or both of: (i) maintenance and repair costs and (ii) units damaged and units returned to service. The pool management system also performs analyses of pool administration data. These analyses comprise one or more of the following: billing summary reports, revenue distribution summary reports, operations expense and revenue summary reports, and licensing reports.

Also in accordance with the invention, a computer-based data analysis system for managing a pool includes: database server means for processing pool data; storage means communicating with the database server means for storing pool data; one or more user terminals for access to the database server by users of the system; and application server means for communicating between the user terminals and the database server. The system further includes first means for specifying an analysis to be performed, and second means, responsive to the first means, for performing analyses of pool data according to the criteria of the selected analysis. The first means includes means for selecting a pre-defined analysis to be performed from among a list of pre-defined analyses and means for creating an analysis by selecting or entering the appropriate value for each relevant parameter from among a list of available parameters. The second means includes an expert system. The analyses performed by the second means are based on pool performance data, maintenance and repair data, and pool administrative data.

Also in accordance with the invention, a computer-based data processing method for managing a pool of fungible items, includes the steps of: processing input data regarding the items in the pool; storing the input data; accessing the input data with a database server; extracting and analyzing the input data according to analysis parameters specified by a user; and displaying to the user the results of the analysis of the input data. The step of extracting and analyzing the input data may further include the step of the user choosing to analyze input data relevant to one of the categories of: pool performance, maintenance and repair, or pool administration.

The step of extracting and analyzing the input data may itself include applying an expert system to the input data, the expert system being provided with the analysis parameters and predefined pool operation rules. In this case, the step of displaying the results includes the presentation of the expert system's diagnostic comments to the user.

Also in accordance with the invention, a computer-based data processing method for managing a pool comprises the steps of: processing input data regarding the in the pool; storing the input data; accessing the input data with a database server; extracting and analyzing the input data according to analysis parameters specified by a user; and displaying the results of the analysis of the input data to the user.

The step of extracting and analyzing the input data may further include the steps of: (i) the user choosing to analyze input data relevant to one of the categories of: pool performance, maintenance and repair, or pool administration and/or (ii) the step of extracting and analyzing the input data may include applying an expert system to the input data to provide inferences based on the analysis parameters and predefined pool operation rules. In this case, the step of displaying the results further includes the presentation of the expert system's diagnostic comments to the user.

The pool management system of this invention is of a higher order of sophistication and detail than those previously used for pool management. It includes more advanced data manipulation techniques, thereby achieving increased ability for participating companies and the pool manager to access, manipulate, and view pool data as compared to known systems and methods. Furthermore, the type and extent of data input/output options available make the system and method of the present invention compatible with a far greater range of applications than known systems.

Although the preferred embodiment hereinafter described relates to pool management, one skilled in the art would recognize that the system and method are applicable to other pooled fungible goods and services.

### BRIEF DESCRIPTION OF THE DRAWINGS

These and other features, aspects, and advantages of the pool management system (“PMS”) of the present invention will become better understood by reference to the accompanying drawings, following description, and appended claims, where:

FIG. 1 illustrates a schematic system diagram of a system according to a preferred embodiment of the invention;

FIG. 2 is a schematic flow diagram of the PMS overall processing when accessed by an end user;

FIG. 3 is a schematic flow diagram of the PMS processing for the pool analysis process and Maintenance and Report analysis process steps;

FIGS. 4A-4H illustrate various exemplary PMS pool analysis process output screens;

FIGS. 5 schematically illustrates the various files involved in executing an analysis process, and the location of those files among the local computer, the application server, and the database server;

FIG. 6 is a schematic flow diagram of the expert system processing associated with PMS pool and Maintenance and Repair analysis processes;

FIGS. 7A-7B illustrate various exemplary PMS Maintenance and Repair analysis process output screens;

FIGS. 8A-8B illustrate exemplary PMS screens for various line accounting reports; and

FIG. 9 is a schematic flow diagram of the PMS processing for the data tracking step.

### DETAILED DESCRIPTION OF THE PREFERRED EMBODIMENT

This invention includes a computer-based tool for analysis of chassis pool management, called herein PMS. PMS is an on-line data analysis system which may utilize a graphical user interface, an analysis scheduler, and both electronic data interchange (“EDI”) and dedicated data links to shipping companies and intermodal terminal locations. It replaces paper-based record-keeping and reporting of chassis pool operations, although of course the system contemplates that hardcopy versions of the electronic data may be desired for archive purposes. Furthermore, PMS uses data analysis methods which are far beyond the simple ‘spreadsheet-based’ reporting models which are in current use in the chassis pool management industry. Finally, the PMS expert system uses rule-based analysis of the raw data in order to automatically ascertain the existence of actual and potential problems with pool operations, and to suggest actions to be taken to alleviate or prevent such problems.

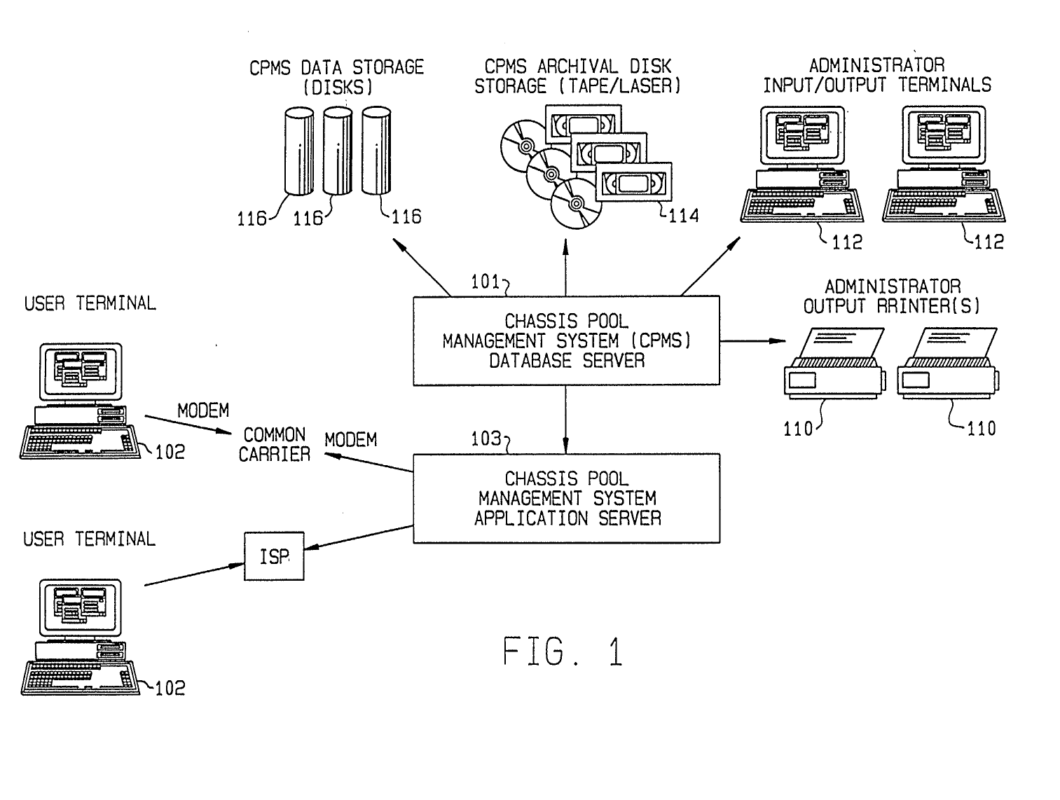

FIG. 1 is a schematic diagram of a typical system configuration according to this invention. PMS has a three-tiered design which utilizes advanced client/server architecture. The heart of the system, the first tier, is the database server 101 which stores all the pool data. The second tier is the application server 103 which makes requests to the database server to analyze sets of data, or runs processes to add, change, or delete data. The third tier consists of the end users or clients, who access the system through a graphical software interface.

The system comprises multiple elements, including a PMS database server 101 that stores and maintains all chassis-related data and performs the processing for the database analyses. Database server 101 may include one or more processors, storage units, control units and communication devices. It interconnects to input/output devices and storage devices such as administrator input/output terminals 112, administrator output printers 110, data storage systems 116 (typically magnetic disk storage systems), and archival data library storage systems 114 (typically magnetic tape or optical disc storage systems). Pool chassis data may be entered by end users from user terminals 102 or administrator input/output terminals 112.

Each user terminal 102 preferably comprises a personal computer running a “windowing” system. User terminals 102 may also have associated printers (not shown). User terminals 102 may be local devices connected via hard wire devices interconnected via a local area network, devices connected via a common carrier network, or other wireless connections.

Computer Hardware, System Software, and Communications

Incorporated into a system according to the present invention are subsystems that use known hardware and software technology.

For example, database server 101 which includes systems for both storing and processing data, could, depending upon the specific size of the chassis pool, use a '486, Pentium, RISC, minicomputer, or mainframe based processor or equivalent. Similarly, disk storage systems, magnetic tape systems, and laser storage systems or their equivalents are entirely adequate for the needs of the system.

The user terminals 102 can be standard personal computers (“PC's”) or similar technology. The user terminals 102 may be provided with a modem capable of at least 14.4 Kbaud data transmission, access to a modem pool, a dedicated internet connection, or access to an Internet service provider. Printers can be of any suitable and compatible design capable of reproducing the text, plots, and figures with adequate resolution.

The application server software, programming languages, and database utilities used for data processing, storage, etc., are also known. The application server software may be selected from UNIX, Windows, Windows NT, Solaris, OS/2, DOS, Macintosh System 7, MVS, or other appropriate software.

Communications among the various devices will depend upon the subsystems selected and the data interchange format preferred by the end users. In particular, intelligent devices within a local or wide area could be connected, for example, by standard TCP/IP technology. Low level devices may be connected using RS-232 units. File servers that are needed could be standard '486 or RISC based devices.

Transmission among system elements can use Ethernet technology with standard Ethernet cards and 10BaseT lines, or token ring technology outside of common carrier domains or any appropriate technology. Standard high speed modems, multiplexors or direct digital transmission, such as by means of packet switching, can be used for long range transmission via common carriers. Using a system according to the present invention, an end user in a shipping company office could be connected to the PMS via: LAN/WAN; modem, through the common carrier system; the Internet, using a commercial internet service provider (“ISP”); or through equivalent means. Furthermore, an end user could be en route and use mobile radio, cellular telephone, or other wireless technology to access the PMS.

Data Flow In/Out Of PMS

Flexibility of data input by the end users is achieved in PMS by providing various data input/output options. The system can provide various electronic data interchange (“EDI”) modalities for data input, such as:

(1) EDI Value Added Network (VAN) messaging: Data may be sent using industry standard messaging formats, such as 322-gate mount/dismount messages, and rail-622 messages. Commercially available EDI VANs include AT&T, GEIS and INFONET, for example.

(2) EDI Packetized E-mail: When users are not following conventional industry standard messaging formats such as 322-gate, it is still possible for them to use EDI VANs by taking an ASCII “flat file” and encapsulating it into an e-mail envelope. This method allows users to take advantage of the storing and forwarding capabilities of EDI VANs while also allowing inclusion of customized data which does not meet industry standard messaging formats. EDI packetized e-mail may be sent over AT&T, GEIS and INFONET just as are EDI VANs, and it can also be sent via MCIMAIL or other appropriate services.

(3) Direct Data Link: Shipping companies and intermodal terminals may link their computers directly to the PMS computer. Using appropriate scheduling functions, the shippers and terminals may send data files to PMS via dedicated dial-up lines or over the Internet. This method avoids EDI VAN charges.

PMS is not limited to these exemplary EDI modalities, rather, as is evident to one of skill in the art, a number of other suitable modalities may be used.

PMS Application Software

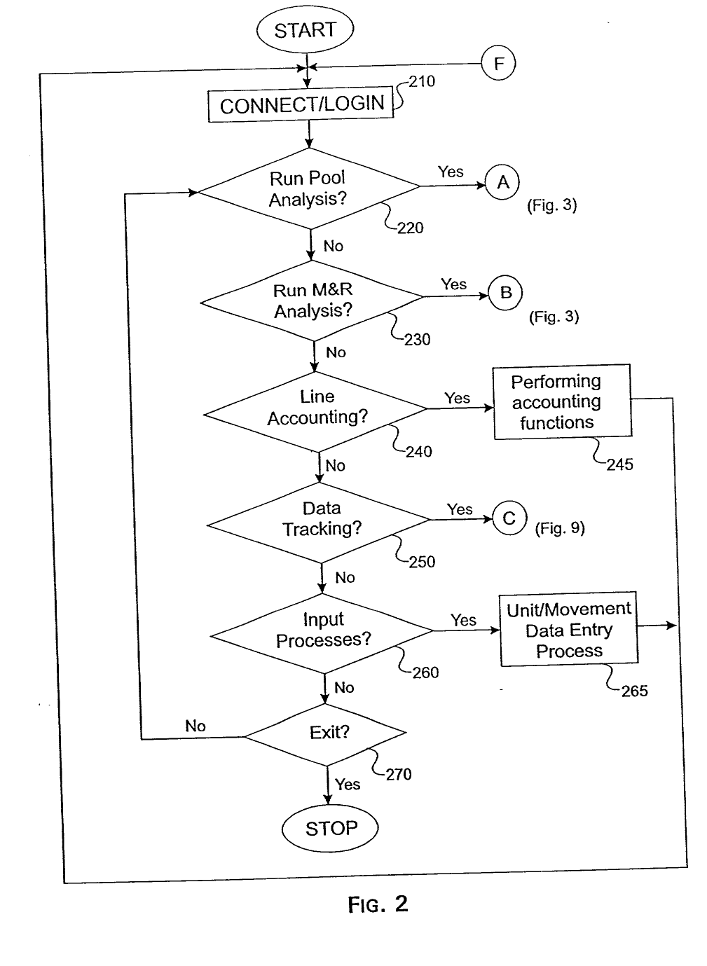

The overall program flow of an illustrative PMS application software program is illustrated in FIG. 2. An end user, typically personnel from a participating company, accesses the system in the connect/log in block 210. Upon logging in to the PMS application, the user is presented with the start-up screen which presents the user with several menu options. In addition to the standard windows application options the start-up screen 301 offers the following unique PMS menu options: Pool Analysis, M&R Analysis, Line Accounting, Data Tracking, and Input Processes.

Selection of the Pool Reports option corresponds to a “Yes” response to decision block 220 of FIG. 2, whereupon processing proceeds as illustrated in FIG. 3. Selection of the M&R Analysis option corresponds to a “Yes” response to decision block 230 of FIG. 2, whereupon processing proceeds as is also illustrated in FIG. 3, although in this case the analyses will be based on M&R data from the database, and the AI-based expert system will be analyzing that M&R data rather than chassis unit and movement data.

Selection of the Line Accounting option corresponds to a “Yes” response to decision block 240 of FIG. 2, whereupon processing proceeds to block 245. In block 245, the PMS user has access to various pre-defined accounting reports as is discussed below.

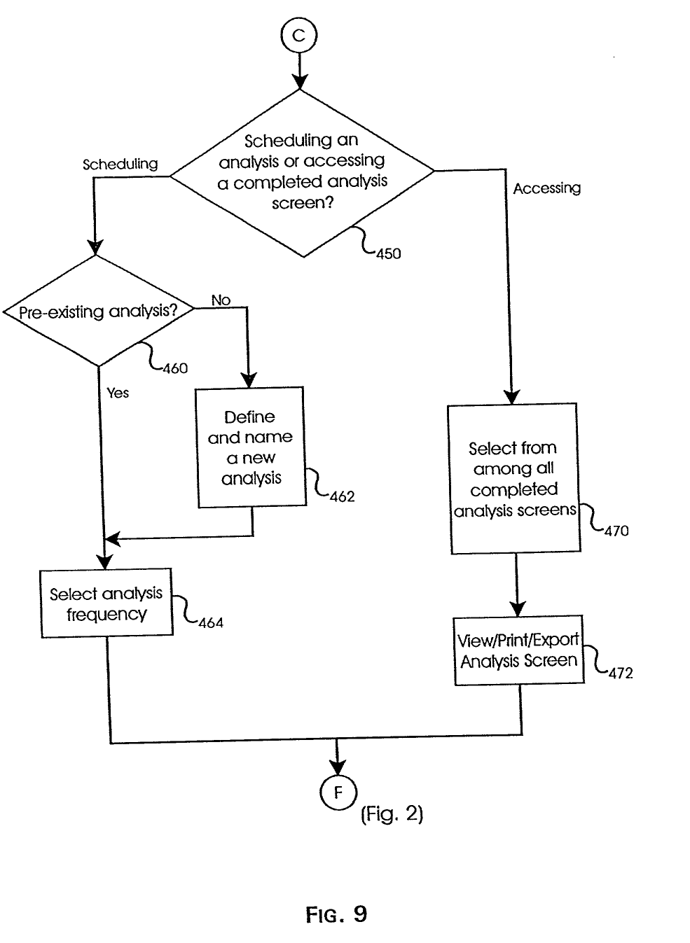

Selection of the Data Tracking option corresponds to a “Yes” response to decision block 250 of FIG. 2, whereupon processing proceeds as illustrated in FIG. 9.

Selection of the Input Processes option corresponds to a “Yes” response to decision block 260 of FIG. 2, whereupon processing proceeds to block 265. In block 265, the PMS user has access to various data entry methods as is discussed in detail below.

When the user is finished with the desired processing offered by the various menu options, he indicates the desire to exit the PMS software, providing a “Yes” response to block 270, and exits the program.

Pool Analysis and Expert System Suggested Actions

This section describes the PMS pool analysis and suggested action report creation function. This software is presented by reference to FIG. 3, without limitation as a step-by-step procedure for defining and executing a pool analysis which provides access to the raw data regarding chassis units and movement, as well as AI-based expert system analysis of trends, problems (actual or potential), and suggested actions.

At block 410, the user may request that an analysis of pool data be performed. Specifically, the user is presented with the choice of executing a pre-existing analysis or defining a new analysis. If he elects to execute a pre-existing analysis (“Yes” response to block 410), processing proceeds to block 412, where he retrieves a pre-existing analysis definition. For example, using known windowing technology, the user may retrieve a pre-existing analysis by selecting an analysis name from a list provided via a pull-down menu bar item. Alternatively, if the user elects to not to execute a pre-existing analysis (“No” response to block 410), processing proceeds to block 414, where a new analysis is defined. If the newly-defined analysis is to be saved (“Yes” response to block 416), then an analysis name is assigned to it in block 418.

Once the desired analysis process has been either retrieved or selected, it is executed at block 420. The resulting analysis process output screen can be viewed, printed or exported at block 422, using the Data Tracking option, discussed in detail below with reference to FIG. 9.

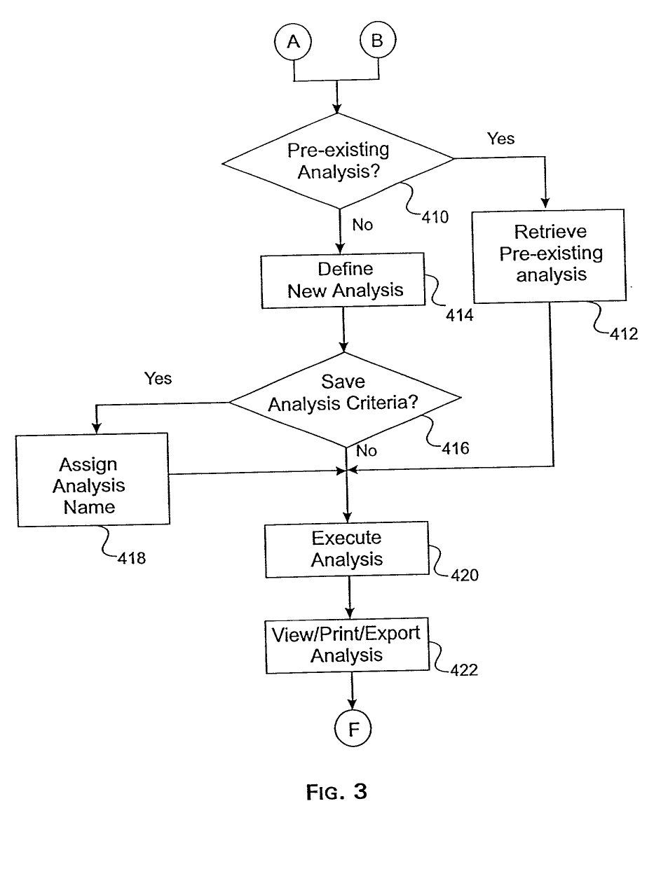

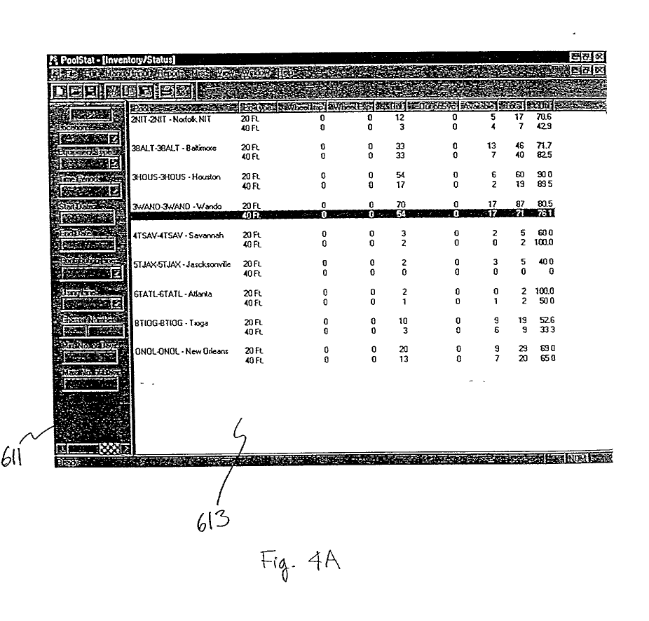

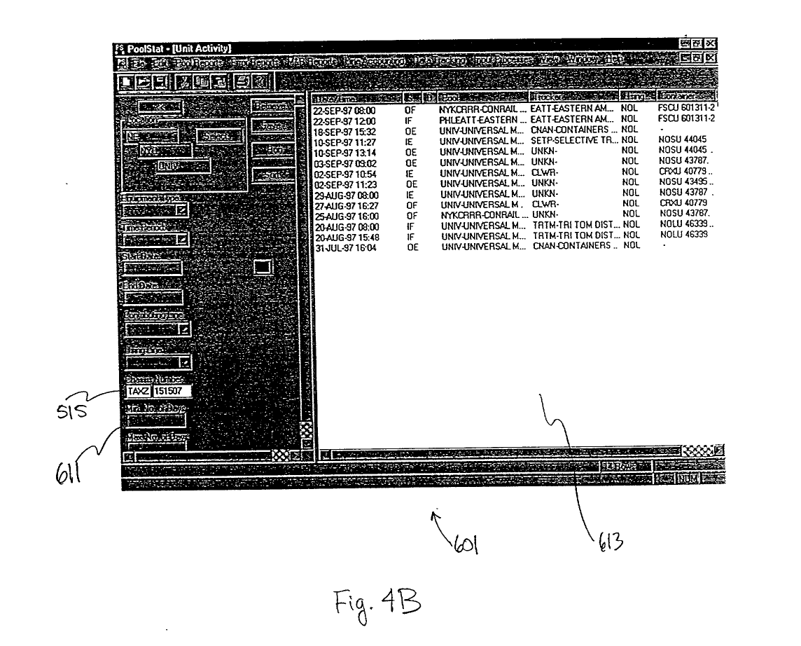

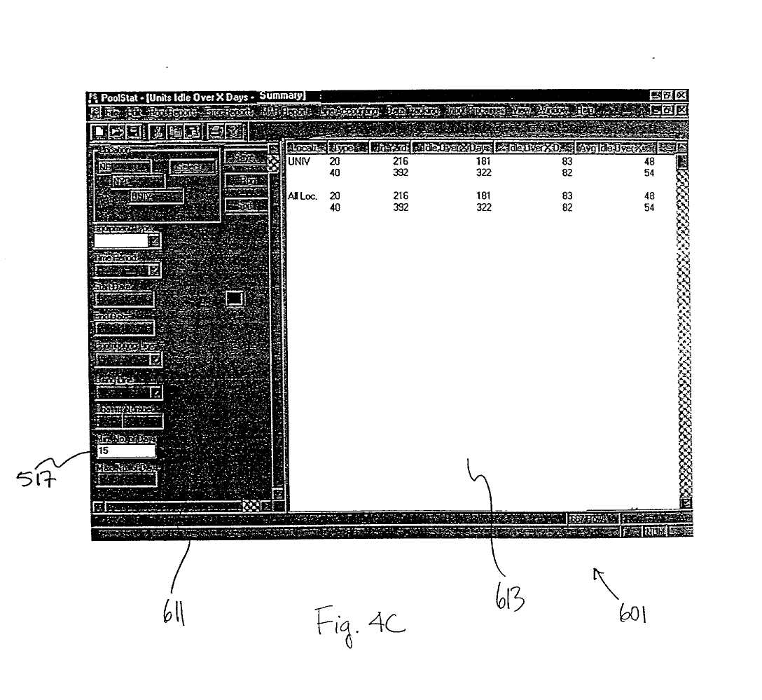

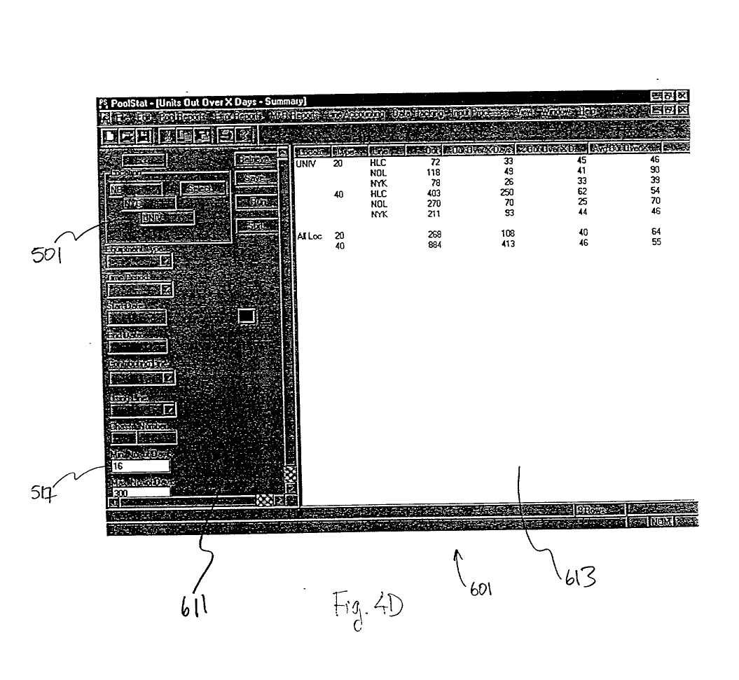

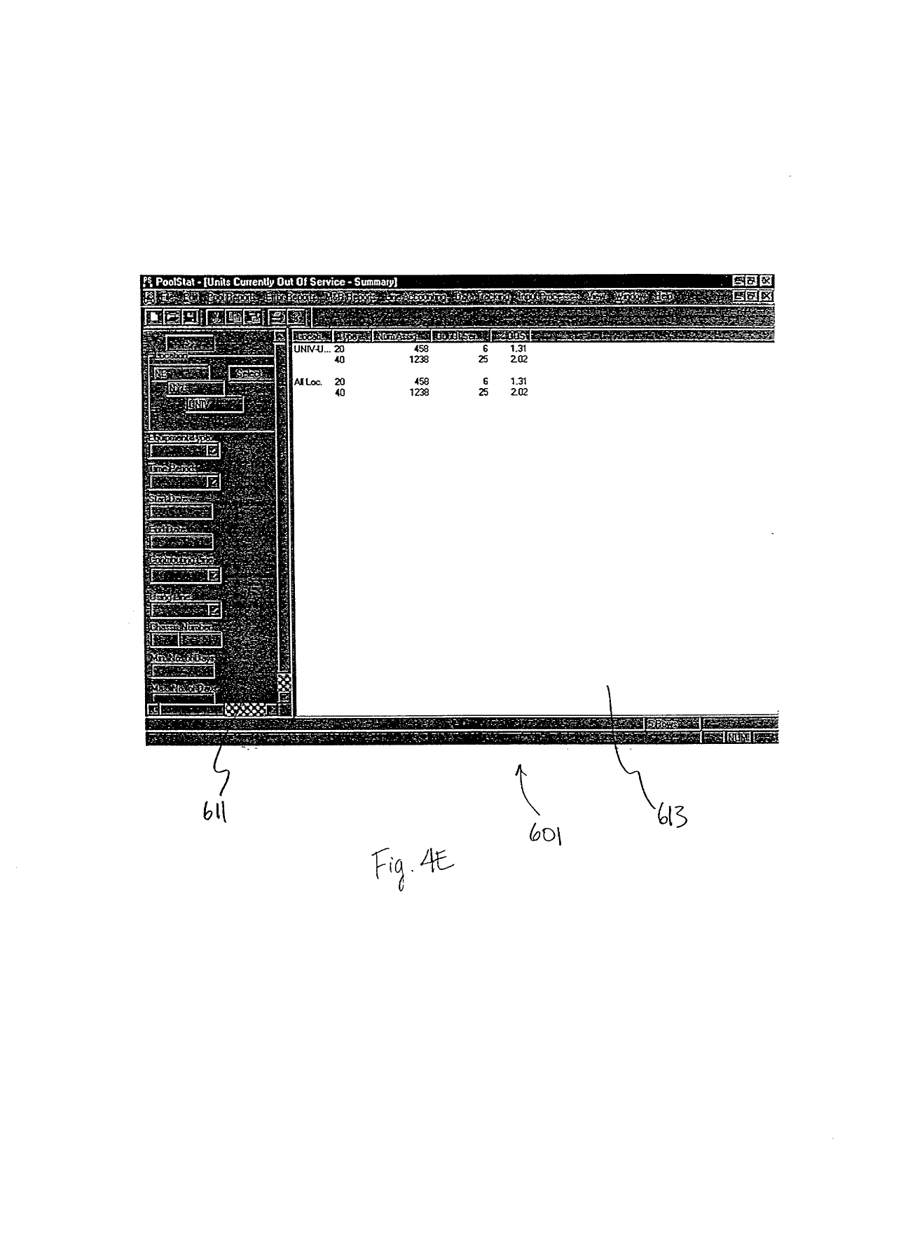

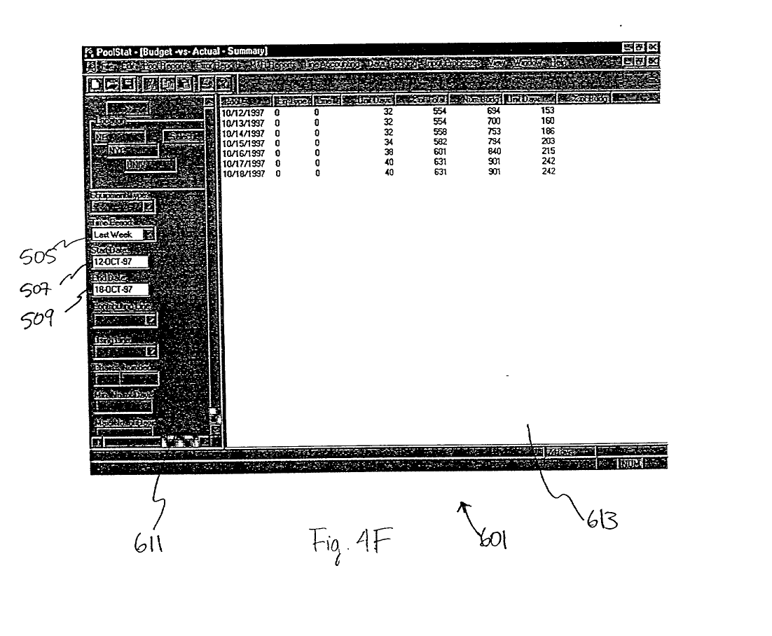

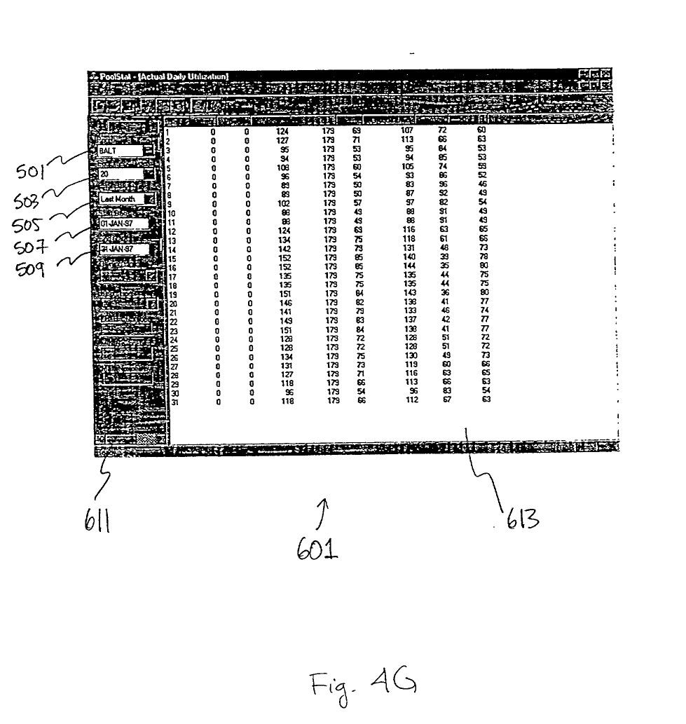

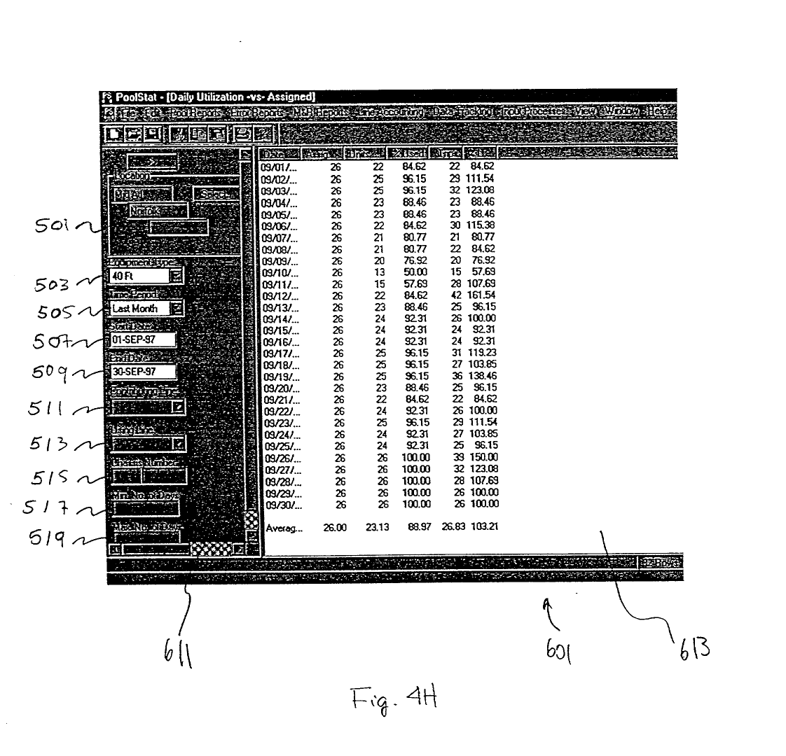

An analysis is defined by the user-selected parameter criteria. Each analysis has numerous variable parameters which control the information which will appear in the completed analysis process output screen. As may be seen in FIGS. 4A-4H, the total parameter set is displayed on one side of the Pool Analysis process output screen in the parameter region 611.

Pool Parameter

The Pool parameter 501 allows the user to choose a region, area, and location from a predefined list. As a particular user may be associated with a company who is participating in more than one chassis pool administrated by the PMS, the user will select the region, area, and location to provide access to the particular chassis pool for which information is currently being sought. A location is a specific intermodal terminal (e.g., New York Gate 1).

Equipment Type Parameter

The Equipment Type parameter 503 allows the user to choose from among standard predetermined chassis types, such as 20-foot and 40-foot chassis. This is an important parameter, as many contribution and utilization numbers are calculated on a “by type” basis rather than for all chassis types combined. For example, in FIG. 4H, the user has chosen to receive and analyze information regarding usage of 40-foot chassis.

Time-Related Parameters

The time related parameters allow the user to control the time period for which data will be analyzed. Time periods may be selected in a variety of ways. First, the user can select from a drop down list of predetermined Time periods 505 (“This week”, “Last week”, “This month”, etc.). Alternatively, the user can specify a date range either by providing a specific date for the Start Date parameter 507 and End Date parameter 509 as seen in FIG. 4H, or by graphically selecting a date range on a built-in calendar.

Contributing and Using Line Parameters

When the user selects a name of a pool participant from the pre-defined drop down list for the Contributing Line parameter 511, only the information for chassis contributed by that line will be analyzed. When the user selects a name of a participating company using the cooperative chassis pool from the drop-down list for the Using Line parameter 513, only the data for chassis utilized by that company will be analyzed.

Chassis Number Parameter

The user can type in an individual chassis unit identification number to obtain information specific to that chassis. For example, in FIG. 4B, the user has entered “TAXZ151507” as the value for the Chassis Number parameter 515. Accordingly, the analysis process output screen 601 of FIG. 4B provides the results of analysis process performed on of the detailed unit activity information for the chassis identified by that number.

Minimum/Maximum Number of Days Parameters

For some analysis process types, the user may enter or select the minimum/maximum number of days as an analysis criterion. For example, in FIG. 4C, the user has entered the value as the value for the Minimum Number of Days parameter 517. Accordingly, the analysis process output screen of FIG. 4C provides summary information on all chassis which have been idle for 15 days or more.

Non-Selectable Parameters

From the examples provided above, it will be evident that not all parameters may be selectable by the user for every analysis process.

One reason a parameter may not be selectable by the user is because the selected analysis process provides a summary analysis process output screen, in which case data corresponding to all values for that parameter will be analyzed and displayed. For example, in the “Units Idle Over X Days Summary” analysis process output screen of FIG. 4C, a majority of parameters are not selectable, as this is an extremely high-level summary screen. Alternately, even though a detail-level analysis process is being performed, certain parameters may simply be irrelevant for that specific analysis process and therefore will not be selectable by the user.

Performing Analyses

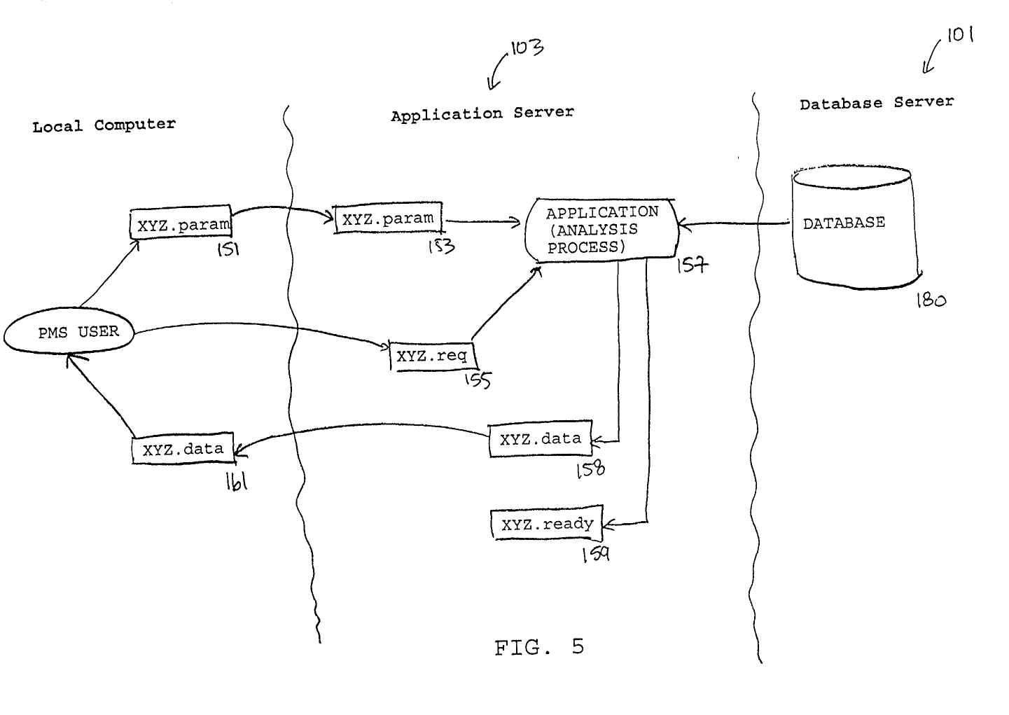

The general process for performing analysis will be discussed with reference to FIG. 5. Once the user has finished specifying analysis parameters, the analysis process is initiated. While the PMS system compiles the analysis data, the Status Bar on the user's computer will read Server Processing.

As an initial step, the PMS system creates a temporary file 151 on the user's local computer. This temporary file contains the parameters that will be used to execute the analysis process. That file is known as the parameter file, and a copy 153 of that file is transmitted to the server, along with the user's system identification and password. The file as it exists on the server is given a unique name, for example XYZ.param, to avoid confusion with other reports being run by other users. Concurrently with the transmission of the temporary parameter file, another file 155 is sent to the application server, containing the name of the analysis process to be performed. That file is known as the request file, and as it exists on the PMS server, also contains the name of the associated “.param” file. The request file is given the same root name as the parameter file, but has extension “.req” (i.e., in this case, XYZ.req). Based on the information in the request file, the server opens the parameter file and reads the input parameters. The server then launches the requested pool analysis process 157 specified in the request file. It is the analysis process which performs the actual data analysis and computations.

Although specific examples of analysis processes will be discussed below, the overall process flow is common to all of the PMS analysis processes. The analysis process flow begins with a verification of the user's system identification and password. This assures that potentially sensitive operational information of the pool participants is accessed only by authorized users. The analysis process 157 then reads in the input parameters, and then queries the database server 101 based on those parameters. The analysis process creates an output data file 158, with the same root name as the parameter and request files (i.e., XYZ.data). After the appropriate information is returned by the database server 101, and all post-processing is complete, the appropriate information is written into the output data file 158. When the writing to the data file is complete, the analysis process creates an process completion file 159 having the same root name as the parameter, request, and output data files (i.e., “XYZ.ready”).

Ever since the requested pool analysis process was initiated, the user's local computer has been polling the application server, looking for the process completion file 159. Once the appropriate process completion file is seen, the user's local computer makes a local copy 161 of the information in the corresponding output data file 158. After the data is received, the local copy of the input parameter file 151, as well as all of the related server files (the server copy of the parameter file 153, the request file 155, the data file 158, and the process completion file 159) are deleted. The copy 161 of the output data file on the user's local computer may be in any appropriate file format, for example flat ASCII or a file format compatible with the flat or relational database being used by the user. The analysis process output screen containing the output data, with column headings and row data, will appear in a window on the local computer's display.

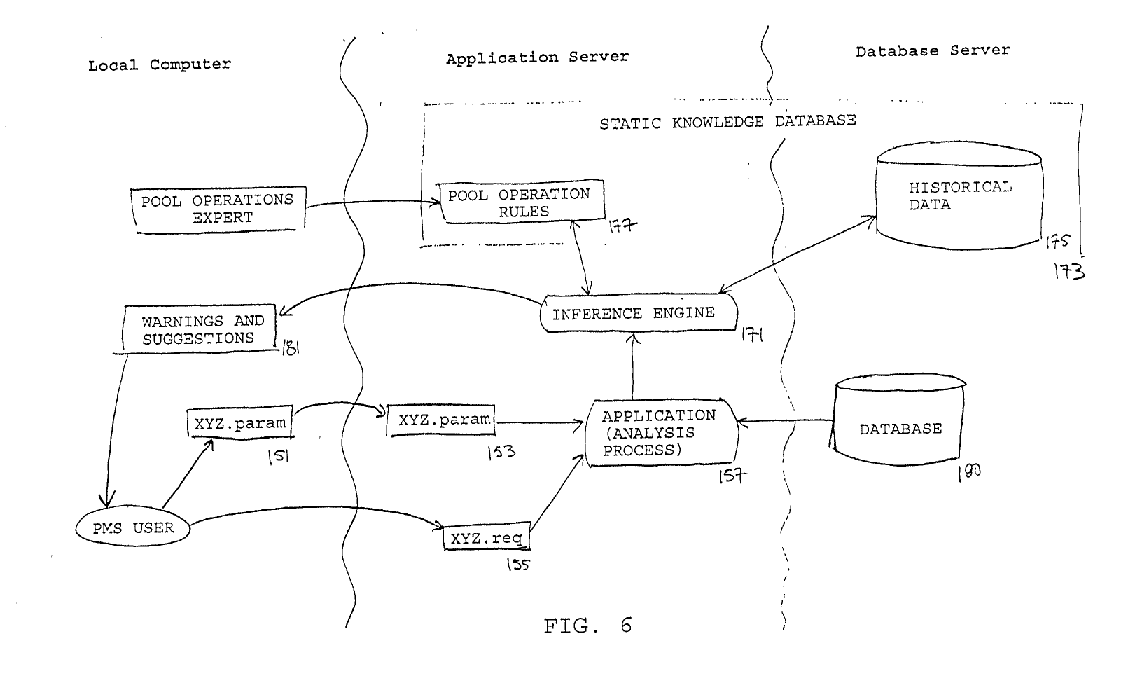

In addition to the tabulated data, the AI-based expert system will analyze the data to determine whether certain problematic operating conditions are indicated. FIG. 6 schematically illustrates the aspects of the expert system, as well as the relevant aspects of the analysis process execution. The expert system applies an inference engine 171 to its knowledge database 173, consisting of historical data (chassis unit and movement data) 175 and pool operation rules (principles of pool operation provided to the expert system by human pool experts via programmers) 177. Furthermore, the expert system will perform a trend analysis to determine whether pool operations can be expected to result in problematic operating conditions if no preventative action is taken.

For example, based on “chassis need” data input by users, such as the imminent arrival of a ship at a marine intermodal terminal, the expert system can perform “needs forecasting”, presenting a forecast as to chassis needed and units available for servicing the vessel. In extreme cases, the system could indicate that a certain number of containers need to be “grounded.” When a large number of containers are arriving, and there is an insufficient number of chassis to accommodate them, some containers must be removed from chassis to make space. Although there are labor and opportunity costs associated with grounding which would preferably be avoided, in extreme cases there is no alternative.

Continued use of the pool management system of the present invention in association with a particular pool will result in an increased data set volume, allowing better insight into trends in the data. The expert system will accordingly be able to predict surpluses and deficits and provide suggestions to the users to allow the pool to be run with an optimal utilization rate while still avoiding, as much as possible, grounding and other inventory-related charges.

Representative Pool Analysis Process Output Screens

In order to illustrate the possible applications of the pool management system of the present invention, presented below are representative analysis process output screens for an embodiment of the invention directed to a cargo container chassis pool.

a. Inventory/Status

FIG. 4A shows an illustrative inventory/status analysis process output screen. This analysis process provides an extremely concise high-level outline of the chassis inventory status, by equipment type, at all locations for the relevant chassis pool. The parameter fields in parameter region 611 of the analysis process output screen are all empty; because of the all-inclusive nature of the analysis process, the user does not need to specify any parameter values to execute this analysis process.

The data is presented in the analysis process result region 613 of the analysis process output screen. Among the information of interest when considering chassis inventory is, for each pool location and equipment type: chassis with containers on them in the terminal; containers coming off ships (“Wheel Imp”), containers going on ships (“Wheel Exp”), the number of pool chassis which are currently being used (“Out”), the number of chassis which are out of service (“Out of Svc”), the number of chassis which are available for use (“Available”), and the total number of chassis currently in the pool (“Total”). In addition to simply listing this information, the inventory/status analysis process output screen can also provide a spreadsheet-style calculation of the current pool utilization level, calculated as ((Out)+(Wheel Imp)+(Wheel Exp))/Total.

b. Unit Activity/History

It is often required that the companies participating in a chassis pool have access to information regarding a specific chassis. This may occur, for example, in response to a request for information regarding a shipment of cargo which is currently en route.

In this case, as illustrated in FIG. 4B, after the user decides to execute the Unit Activity Analysis process, the only information required, or indeed permitted, to be entered is the unique chassis identification number. This value is entered in the Chassis Number field 515 in the parameter region 611 of the analysis process output screen 601, and the analysis process is executed. The analysis process output screen then provides information on movement activity of the chassis from one physical location to another, as shown in the analysis process result region 613 of the analysis process output screen 601 of FIG. 4B.

Information presented to assess individual chassis activity can include: status codes (“Status”), whether damage occurred during the movement activity (“Dmg”), the starting and ending points of the movement (“From” and “To”), the using party (“Using”), the vessel number the container is going to or from (“Vessel”), the identification number for the container loaded on the chassis, (“Container”), the M&R repair record number (“M&R Rec.”), and the length of time the unit was or is in use, known as “turn time” (“Turn”).

As is evident from FIG. 4B, not all of the data columns are simultaneously visible to the user on the analysis process output screen. The user can view additional columns by scrolling, or by adjusting the displayed width of the data columns.

c. Units Idle Over X Days Summary

An important indicator of efficient chassis pool operation is the number of chassis which are lying idle for extended periods of time. Therefore, it is desirable that the chassis pool manager or participants be able to analyze this information. There is no standard period of idle time which the industry considers excessive. Rather, this time period depends on business fluctuations. During a period of heavy shipping activity for the industry as a whole, 20 days may be considered too long, while during quiet periods, 60 days may be acceptable. Therefore, analysis of idle time should accommodate such variations.

Accordingly, the PMS has been designed to allow the user to select a desired value for the idle time, and obtain an analysis of units idle for more than that time duration. FIG. 4C illustrates a summary-level analysis process output screen for units idle for more than 15 days. The PMS user has simply chosen to execute the “Units Idle Over X Days—Summary” analysis process, and has entered the value 15 in the “Min. No. of Days” field 517 in the parameter region 611 of the analysis process output screen. The analysis process result region 613 indicates, by equipment type, the number of chassis currently in the intermodal terminal (“In Yard”), the number of chassis which have been idle for longer than the selected time duration (“Idle Over X Days”), and a derived value for the percentage of chassis which have been idle for longer than the selected time duration (Idle Over X Days/In Yard ×100=“% Idle Over X Days). Furthermore information is provided on how many days on average those chassis have been in the terminal (“Avg. Idle Over X Days”). The above-enumerated information is provided for each pool location, as well as combined values for all locations.

In addition to presenting the users with detailed information on idle chassis, the PMS expert system can provide warnings and/or suggestions to the pool manager or participant regarding the possible root causes of an excessive number of idle chassis or of excessive idle durations for certain chassis. As schematically illustrated in FIG. 6, the expert system typically evaluates information in addition to the tabular data presented in the tabulated analysis process result region 613 of the analysis process output screen. This additional information includes historical data 175 regarding pool operation as well as a set of rules 177 regarding pool operations.

For example, the following expert system rule may be applicable in this context:

IF: The percentage of chassis idle for over X days is greater than 5%

AND: The percentage of chassis idle for over X days is greater than 120% of the historical average (for this season and location)

THEN: There is an excessive percentage of idle chassis.

Although the first conditional part of this rule involves the idle chassis data of current interest to the user, the second conditional part involves historical idle chassis data. This historical data is not presented explicitly to the user, as it is not part of the requested data to be displayed, but serves as part of the basis for the expert system analysis and diagnosis which accompanies the data in the analysis process output screen.

In this instance, if the PMS user wanted to both perform an idle chassis analysis and to obtain expert system advice, the appropriate information would be included in the request file 151 to invoke the expert system. Then, in addition to the execution of the analysis process 157 as discussed above with reference to FIG. 5, the expert system inference engine 171 would first look to the database of pool operation rules 177 for rules relating to idle chassis. Then, based on the data required for evaluation of the relevant rules, the engine would look to the database of historical data 175, as well as the data for the time period of interest, as resulting from the execution of the analysis process 157.

The user may also obtain a detailed analysis of chassis units at a specific location which have been idle for over a specified number of days. The analysis is executed by selecting “Units Idle Over X Days—Detail” analysis process, and entering the relevant values for the Pool parameter 501 and Min No. of Days parameter 517 in the parameter region 611 of the analysis process output screen. Once executed, the analysis process output screen provides detailed information for the chassis at that intermodal terminal which have been idle for a period exceeding the selected number of days. The information can include: the unique chassis identification number (“Chassis Number”), the equipment type (“Description”), the company contributing that chassis to the pool (“Owner”), the date when that chassis last came into the intermodal terminal (“Date In”) and the number of days the chassis has been idle (“Days In Pool”).

d. Units Out Over X Days

Another important measure which provides an indication of efficient pool operation is the number of chassis which are in use (i.e., which are outside of the intermodal terminal) for extended periods of time. Accordingly, the PMS provides for the automatic execution of analyses providing this information. FIG. 4D shows an illustrative “Out Over Given # of Days Summary” analysis process output screen. In order to execute this analysis process, the user simply selects the analysis process name from the pull-down menu, and enters the pool location in parameter field 501, and the time duration of interest in parameter field 517, both in the parameter region 611 of the analysis process output screen 601.

Similar to the “Units Idle Over X Days Summary” analysis process output screen of FIG. 4C, this output screen indicates, by equipment type and by the contributing party (“Line”), the number of chassis which have been out of the location for more than the specified number of days, as well as derived percentage and average values.

If more detail is desired, the user can perform a “Units Idle over X Days—Detail” analysis process, in which case information is provided for each of the individual chassis at that location which have been in use for the specified period. In addition to the information provided in the summary analysis process output screen, the information provided may include: the unique chassis identification number (“Chassis Number”), the equipment type (“Description”), the company contributing that chassis to the pool (“Owner”), the date when that chassis left the intermodal terminal (“Date Out”) and a number identifying the trucking line which is using the chassis (“Trucker”).

e. Units Currently Out of Service

Together with the analyses of the units in use and the idle units, an analysis process of the units out of service provides a complete ‘snapshot’ of the chassis pool inventory status at a given time. A large number of out of service units may indicate that the chassis in the pooled fleet are getting advanced in age and may require replacement, that M&R schedules may need to be adjusted, or possibly that established M&R schedules and procedures are not being adhered to. Accordingly, PMS provides for automated execution of out of service analyses. FIG. 4E shows an illustrative “Units currently Out Of Service Summary” analysis process output screen. In order to execute this analysis process, the user simply selects the analysis process name, and executes the analysis process—no parameter values need to be specified.

The analysis process output screen provides information on all chassis at all locations for the user's pool which are currently out of service. The information provided for each location and equipment type typically includes the number of units which are “assigned to” that location, i.e. units which are either in the terminal or outbound from that terminal (“Num Assigned”), and the number of units which are out of service (“Out of Service”). As illustrated in FIG. 4E, the analysis process output screen may also provide a derived value for the percentage of assigned units which are out of service (“%OOS”).

In order to diagnose problems with M&R procedures, it is also useful to provide chassis pool participants with detailed out of service information for specified pool locations and equipment types, providing in-depth information regarding the specific chassis which are out of service. Accordingly, a “Units Currently Out Of Service—Detail” analysis process output screen may provide information such as: the date and time when the chassis went out of service, a code indicating chassis status (such as in/out bound, full/empty, wheeled in/out bound, and bare of a container), a code indicating whether the chassis went out of service due to damage rather than routine wear and tear, the pool participant who was using the chassis when it went out of service, an M&R report number for record-keeping purposes, and the unique chassis identification number.

f. Budget-vs-Actual

In order to assist the pool manager and participants in evaluating historical operating efficiency of the pool and to assist in planning and forecasting future operations, PMS performs analyses comparing actual utilization with budgeted amounts. To execute such an analysis process, as illustrated in FIG. 4F, after selecting the Budget -vs- Actual Analysis process, the user simply provides the time period of interest. This can be accomplished by selecting a pre-defined time period (“Last Week”, “Last Month”, etc.) from the pull-down list provided in the “Time Period” field 505 of the parameter value region 611 of the analysis process output screen. In the illustrative analysis process output screen of FIG. 4F, the user has selected “Last Week”, and the PMS has automatically entered the “Start Date” and “End Date” values corresponding to that selection. Alternatively, the user could directly enter desired values for the starting and ending dates in the corresponding parameter fields 507, 509. After the time period is defined, the analysis process is executed.

The summary analysis of actual versus budgeted utilization provides the following utilization information by pool location (“Pool”), by equipment type (“Eq Type”), and by participating company (“Line”): actual chassis utilization in units of chassis-days (or unit-days) (“Unit Days”), the actual utilization by each participating company relative to total pool utilization (“% of Total”), the budgeted number of chassis (“Num Budg”), budgeted chassis utilization in units of chassis-days (“Unit Days Budg”), and the budgeted utilization for each participating company relative to total budgeted utilization (“% of Budg”).

In conjunction with the analysis of the actual and budgeted utilization data, the PMS expert system can perform a trend analysis following the general process described above with reference to FIG. 6. In this context, the expert system would assist the users in assessing the causes of excessive variations from budgeted utilization levels and would provide suggestions for how to resolve such problems. For example, the expert system could automatically compare the current actual utilization data with historical values and then determine that all participating lines have consistently come very close to or exceeded the budgeted utilization levels at the Baltimore location. Accordingly, the expert system could automatically send a message to the users or the pool manager to the effect that, for example: “Note: Budgeted utilization value for BALT appears to be too low—consider increasing budget by 12%”. The message could be sent in conjunction with the execution of the analysis illustrated in FIG. 4F, or alternatively could be generated and sent as the result of an analysis performed specifically for the purpose of obtaining expert system suggestions.

g. Daily Utilization-vs-Budget

In order to obtain more detailed utilization information than that available from the Budget-vs-Actual Summary analysis process output screen, and to provide a chronological perspective on utilization, PMS may provide the users with a Daily Unit Usage-vs-Budget analysis process, as shown in FIG. 4G. As for the Budget-vs-Actual Summary analysis process, the user provides a time duration of interest (using parameter field 505, or 507 and 509). In addition, the user provides a specific pool location (parameter field 501) and equipment type (parameter field 503). The executed analysis process then provides, on a day-by-day basis, actual and budgeted utilization information for the pool as a whole.

The information which may be provided to assist chassis participants in analyzing their utilization on a daily basis can include: containers coming off of ships (“Wheel In”), containers going onto ships (“Wheel Out”), actual chassis utilization in units of chassis-days (“Unit Days”), budgeted chassis utilization in units of chassis-days (“Budgeted”), the actual utilization relative to budgeted utilization (“% Util”), the number of unique chassis units used during the period (“Unique Units”), the numbers of unused units (“Avail”), and the percentage of budgeted units which were actually utilized (“Unit Util”).

For example, the analysis process output screen shown in FIG. 4G provides an analysis of daily unit usage during the month of January 1997 for 20-foot chassis at the Baltimore location. The first line of the analysis process result portion 613 of the screen indicates that on Jan. 1, 1997, 107 “Unique Units” were used for 124 “Unit Days” charged to all the participants combined. A single “Unique Unit” may be used by more than one line in a single day, resulting in unit day charged to each of the using lines, and thereby resulting in a figure for “Unit Days” exceeding the figure for “Unique Units.” The “Util” is calculated as the percentage of budgeted unit days which were actually charged to the participants. The Unit utilization “Unit Util” is calculated as the percentage of budgeted units which were actually utilized:

$$\% Util = \frac{Unit Days}{Budgeted} \times 100 \%$$

The PMS may also provide a graphical presentation of the daily actual and budgeted utilization data which is represented in tabular format in FIG. 4G. Such graphical data presentation will allow the PMS user to obtain a quick, intuitive understanding of the utilization trends during the time period.

h. Actual Daily Utilization

Actual utilization of the chassis fleet is ultimately the most direct indicator of efficient chassis pool operation. While all of the analyses discussed herein provide useful insight into various aspects of pool operations, actual utilization is the true measure of pool efficiency. Therefore, PMS provides an Actual Daily Utilization analysis process, as shown in FIG. 4H. As for the Daily Unit Usage-vs-Budget analysis process output screen of FIG. 4G, the user provides pool location, equipment type, and the date range in the appropriate parameter fields in the parameter region 611.

Information which may be provided to assist chassis participants in analyzing their actual utilization on a daily basis can include: the number of chassis assigned to that participant (“Assigned”), actual chassis utilization in units of chassis-days (“Units Used”), a derived value for the percentage of total chassis utilized (“% Used”), chassis utilization in terms of unit trips (“Trips”), and the percentage of budgeted units which were actually used (“% Util”). Because a single physical unit can make more than one trip on the same day, the number of unit trips may exceed the number of units used.

i. Imbalance

Due to the fact that a chassis pool arrangement typically can include several distinct geographic locations (intermodal terminals), it is important to monitor not only the overall chassis inventory, but also the inventory level at each individual location. One indicator of inventory level change is the Imbalance measure, which provides information on the effect of chassis unit inventory at each pool location caused by movement of chassis units between pool locations.

In order to execute an Imbalance-Summary analysis process, the PMS user simply selects that analysis process type and executes it—no parameter values are required. The analysis process output screen provides the net change in chassis unit inventory at each location (“Change”) and average turn time (“Turn”), broken down by pool location, equipment type, and pool participant. A standard turn time is the elapsed time from the moment a chassis goes out the gate from a terminal to the time it comes back in.

To obtain more detailed imbalance information, the user can perform an Imbalance-Detail analysis process. As with the Imbalance-Summary analysis process, no parameter values need be entered, however, more information is made available in the Imbalance-Detail analysis process output screen. The Imbalance-Detail analysis process output screen provides information on each individual chassis unit which has moved from one location to another.

j. Turn Time

Evaluation of turn time is an important complement to utilization and imbalance analyses, as a unit making a single month-long trip would show a 100% utilization, but would only have served one customer one time. Evaluation of turn time averages and distributions can provide useful insights into pool operation efficiency. To run such an analysis, after selecting the Turn Time Analysis-Summary analysis process, the user simply provides the time period of interest.

The summary analysis process output screen of turn time performance provides the following information by pool location (“Location”) and by equipment type (“Type”): chassis which are not in use or have no containers loaded on them (“Idle/Bare”), containers coming off ships (“Wheel Import”), containers going on ships (“Wheel Export”), the number of chassis currently in use (“Out”) , and units out of service (“Out of Svc”).

If more detailed turn time information is desired, the PMS user can select the Turn Time Analysis Detail analysis process, and enter the following information in the appropriate fields in the parameter region 611 of the analysis process output screen: the specific pool location to be evaluated, the time period of interest, and the maximum number of days, and execute that analysis process. The resulting analysis process output screen will provide a tabulated profile of turn time distributions, as well as derived values for total, mean, and median turn times.

k. Trips Per Unit Per Month

A complement to the turn time analysis is an analysis of trips per unit per month. This high-level summary graphical data presentation is executed by the PMS user simply by selecting the Trips Per Unit Per Month analysis process and executing it—no parameter values are required. The analysis process output screen provides a graph of the average number of trips per month for all chassis in all locations of the user's pool. This analysis process is useful for long-term trend analysis. For example, inspection of the analysis process output screen might indicate that during turn times are typically higher in the fall, and lower in the spring. Such information could be used by pool participants to inspect other aspects of pool operations during the spring, to respond to the reduced turn time efficiency.

Maintenance and Repair (“M&R”) Information

PMS maintains a database of all repairs, containing numerous M&R-related variable data. The database is accessible to users via a variety of analyses, both pre-existing and user-defined. Any combination of the following examples of M&R-related variables can be chosen to create an M&R analysis:

a. Date range;

b. Repair category (wear or damage);

c. Repair type;

d. Repair component/material;

e. Repair location (where was repair made on chassis);

f. Repair vendor/geographic location;

g. Chassis number;

h. Using line;

i. Contributing line.

Representative M&R Analyses

a. M&R Cost

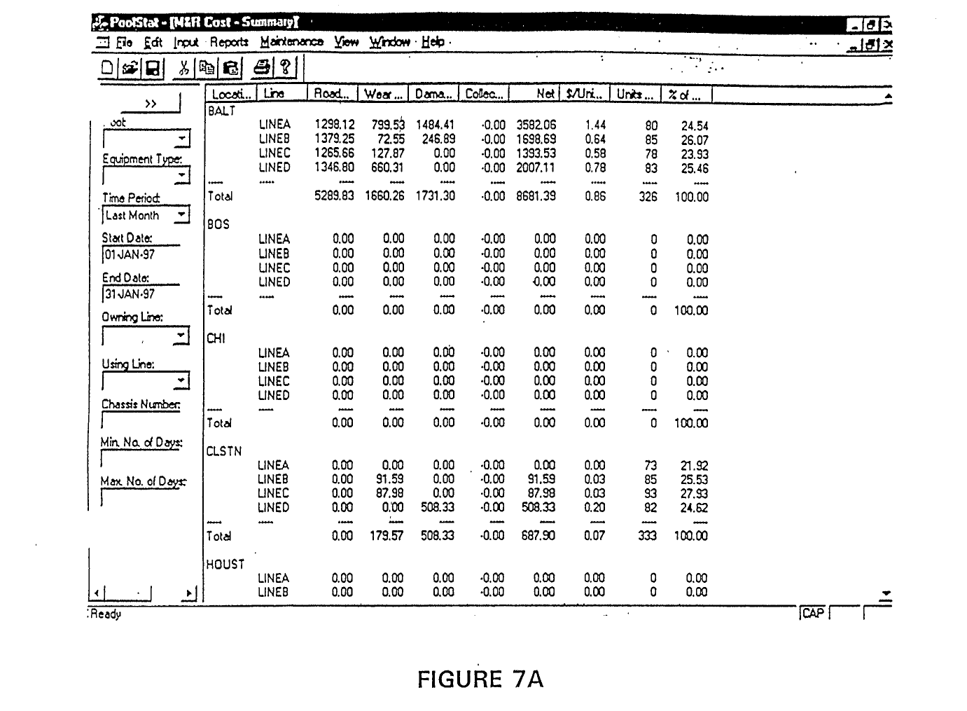

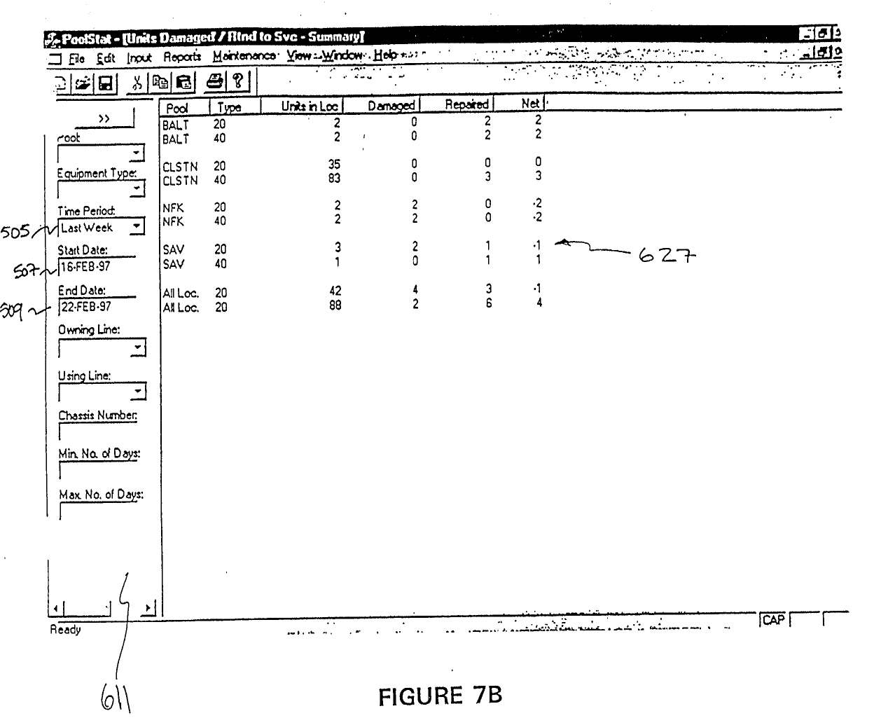

It is important for pool participants to be able to track M&R expenses, to evaluate trends (such as excessive expenses at a particular pool location) as well as for standard financial budgeting purposes. Therefore, PMS provides automated analyses of M&R costs. The M&R Cost summary analysis process output screen of FIG. 7A is obtained by the user simply selecting a time period of interest and executing the analysis process—no specific parameter values are required. The M&R Cost analysis process output screen may provide the following information by pool location and by participant: roadability costs (primarily tire repair and replacement) (“Roadability”), wear and tear costs (not related to discrete damage events) (“Wear & Tear”), damage repair costs (“Damage”); the amount of billed costs collected (“Collections”), the number of chassis units involved in M&R activities (“Units . . . ”), and derived fields for net M&R costs (“Net”), amount spent on M&R per unit per day (“$/unit/day”), and the percentage of usage days used by each line (“% of . . . ”).

In conjunction with the tabulated data presented in FIG. 7A, the expert system may provide warnings and suggestions regarding M&R expenses. For example, based on its analysis of historical M&R data, and based on programmed “rules”, the expert system might indicate that “Current damages expenses for BALT far exceed historical seasonal values, or that the number of damaged units is ABOUT AVERAGE. Examine individual service reports to determine the reason for excessive damages expenses.”

b. Units Damaged/Returned to Service

It is desirable to be able to evaluate the efficiency of M&R operations, in order to try to improve the efficiency of internal procedures, or possibly to change vendors if M&R services are not being performed by the pool participants themselves. Accordingly, PMS provides analysis of servicing of damaged units.

As shown in FIG. 7B, the user can obtain an analysis of Units Damaged/Returned to Service by providing the time period of interest in the parameter value region 611 of the analysis process output screen using parameter 505 or 507 and 509. The analysis process output screen then provides, by pool location and equipment type, the following information: the total number of chassis units (“Units in Loc.”), the number of units which were damaged (“Damaged”), the number of units which were repaired and returned to service (“Repaired”), and a derived value for the net effect of damaged and repaired chassis on available chassis inventory (“Net”). For example, the analysis process output screen line 627, for 20-foot chassis at the Savannah location, indicates that of the three chassis in inventory, two were damaged during the period of interest. However, line 627 further indicates that one chassis was repaired and returned to service, such that the final effect of damages and repairs on chassis availability was the net loss of one chassis.

Line Accounting

In addition to the sophisticated data tracking and analysis features of the PMS, the information contained in the PMS also permits the performance of traditional accounting and billing functions.

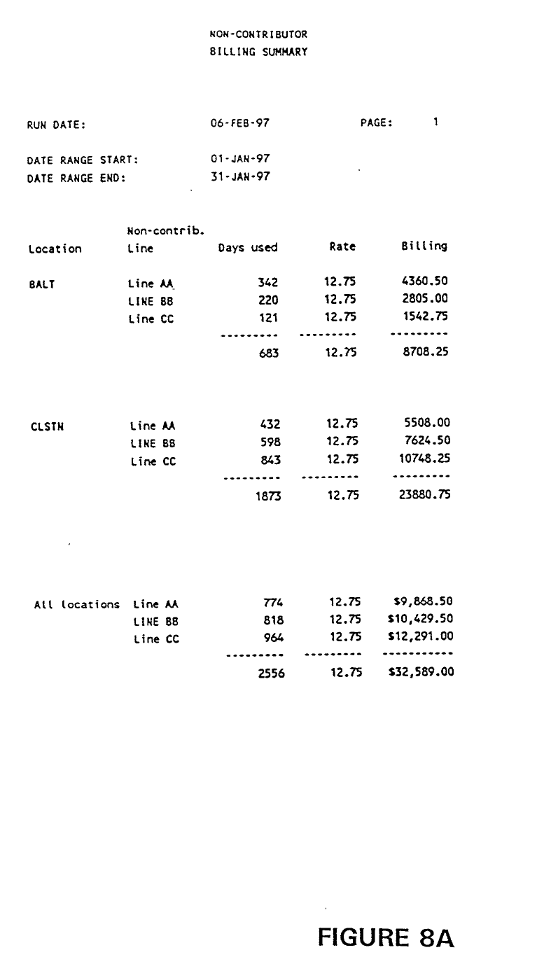

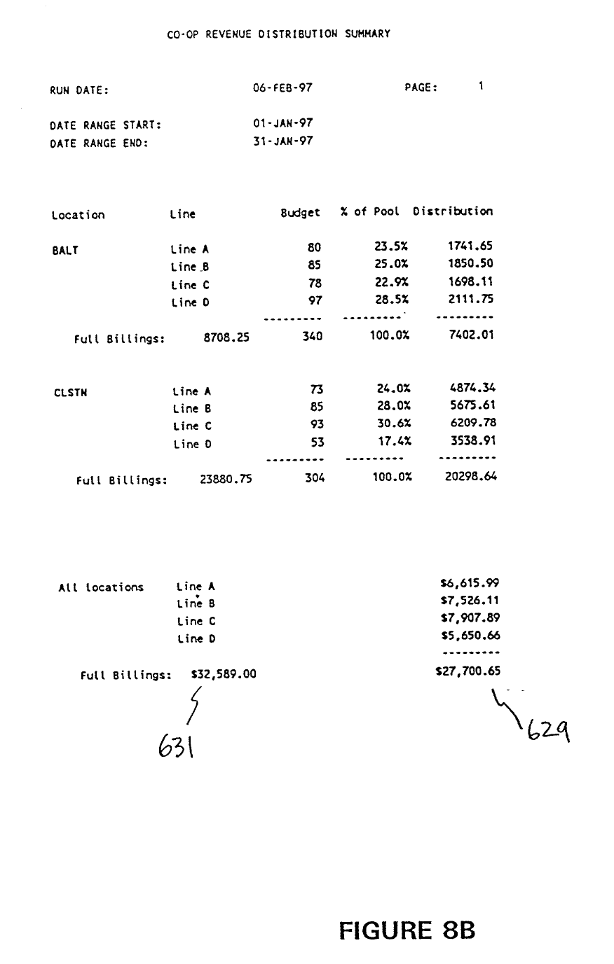

For example, since the PMS database tracks chassis utilization, it can generate invoices and billing summaries based on utilization for both pool participants as well as non-participating lessees. FIG. 8A illustrates an illustrative billing summary for the month of January, 1997. It summarizes the billing to non-participating shipping lines “AA”, “BB”, and “CC”, which lines utilized pool chassis at the Baltimore and Charleston locations. Based on the amount of utilization (measured in days used) multiplied by the non-participant per diem ($12.75 in this example), the billing summary indicates that $32,589.00 was or is to be billed to non-contributing lessees.

FIG. 8B illustrates a revenue distribution summary report corresponding to the billing summary of FIG. 8A. The revenue distribution summary indicates how the pool revenue is to be distributed among the pool participants. The PMS allows for custom programming of the rules for revenue distribution—once the rule is entered into the system, the revenue distribution reports will run according to the same rule each time it is run. The example of FIG. 8B shows a report for a simple pro rata distribution among the pool participants, based upon their percentage contribution to the chassis pool inventory at each location. It can be seen that the total distribution FIG. 629 is less than the full billings 631. The difference, fifteen percent in this example, is the administrative management fee charged by the pool manager.

The PMS can also generate Operations Expense/Revenue summaries tabulating expenses incurred, and revenues realized, by pool operations in a given period. Expenses include repairs related to roadability, wear & tear, damage, and Management Fees. Revenues come from non-contributor billings and collections.

A routine, but important, task of the pool manager is to ensure that the pool chassis comply with all regulatory licensing requirements; this typically consists of renewing licenses in a timely manner. Thus PMS can also generate License Reports directed to chassis for which licensing events will occur during a specified time period. This report indicates the chassis numbers for which licenses will be up for renewal during the indicated time period.

These and similar data presentation reports are easy to obtain due to the comprehensive data set managed by the PMS. Indeed, these reports can be automated to run at scheduled intervals, so that important billing or license renewal dates will not be inadvertently missed.

Data Tracking

The Data Tracking menu option provides access to analysis scheduling, viewing of executed analysis process output screens, exporting of analysis results, and printing of analysis results. The program flow for the data tracking option is shown in FIG. 9.

Within the data tracking option, the user chooses, at block 450, between scheduling an analysis process to be run in the future, or accessing a completed analysis process output screen. If the user chooses to schedule an analysis process, processing proceeds to block 460, where the user either selects a pre-defined analysis process or decides to define and name a new analysis process in block 462. The user then schedules the analysis process to run unattended in lock 464. The user may select a pre-defined analysis process execution frequency (Hourly, Daily, Weekly, etc.) or may select a desired frequency or specific date and time for the analysis process to be executed.

Scheduled analyses which have run in unattended mode are saved for subsequent viewing and disposition by the user. If the user in the Data Tracking option chooses to access a completed analysis process output screen, processing Droceeds to block 470 of FIG. 9, where the user selects from among all completed analysis process output screens. Once the user selects the analysis process output screen of interest, processing proceeds to block 472 of FIG. 9, where the analysis process output screen can be viewed, printed, or exported (to a variety of standard application formats).

Input Processes

The Input Processes menu option provides access to the various methods for importing chassis pool data into PMS. PMS supports traditional ‘batch file’ data importation. In this method, the pool participants provide batch files (in flat ASCII or a recognized application program format, such as a spreadsheet file) containing their chassis unit and movement data. PMS then parses the data to put it into standardized format for use by the database server 101, so that the users can execute analyses based upon that data. PMS also provides direct input methodologies, wherein the users can manually enter unit and movement data directly in the form usable by the database server 101.

### SPECIFIC EMBODIMENTS

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims.

For example, it will be clear to one of skill in the pertinent art that the pool management system of the present invention can be used with pools of various fungible items and services in addition to cargo container chassis. For example, the pool management system could be modified for use in managing a fleet of pooled vehicles such as taxicabs or delivery trucks. The modification of the pool management system for use with such a pool would simply require modification of the data fields stored in the database to reflect data pertinent to vehicle pools, and modification of the expert system rules to reflect specific rules governing operation of vehicle pools. It is also clear to one skilled in the art that the fungible items of the invention are not limited to vehicles.

What is claimed is:

1. A computer-based data analysis system for managing pool of fungible items, comprising:
(a) database server means for storing and processing pool data;
(b) one or more user terminals for access to said database server means by users of said system;
(c) application server means for communicating between said user terminals and said database server means;
(d) first means for specifying an analysis of pool data to be performed; and
(e) second means, responsive to said first means, for performing analyses of pool data according to the criteria of the selected analysis.

2. The system of claim 1 wherein said first means comprises means for selecting the analysis to be performed from among a list of pre-defined analyses.

3. The system of claim 1 wherein said first means comprises means for creating an analysis by selecting or entering the appropriate value for each relevant parameter from among a list of available parameters regarding pool operations, such that the pool analysis performed according to the selected or entered parameters will provide an analysis of the desired aspects of pool operations.

4. The system of claim 1 wherein said second means comprises an expert system, said expert system applying pre-defined rules regarding pool operations to provide diagnostic comments regarding the pool data.

5. The system of claim 1 wherein the analyses performed by said second means are based on pool performance data, maintenance and repair data, and pool administration data.

6. A computer-based data analysis system for managing a chassis pool, comprising:
(a) database server means for storing and processing chassis pool data;
(b) one or more user terminals for access to said database server by users of said system;
(c) application server means for communicating between said user terminals and said database server;
(d) first means for specifying an analysis to be performed; and
(e) second means, responsive to said first means, for performing analyses of chassis pool data according to the criteria of the selected analysis.

7. The system of claim 6 wherein said first means comprises means for selecting the analysis to be performed from among a list of pre-defined analyses.

8. The system of claim 6 wherein said first means comprises means for creating an analysis by selecting or entering the appropriate value for each parameter from among a list of available parameters regarding chassis pool operations, such that the chassis pool analysis performed according to the selected or entered parameters will provide an analysis of the desired aspects of chassis pool operations.

9. The system of claim 6 wherein said second means comprises an expert system, said expert system applying pre-defined rules regarding chassis pool operations to provide diagnostic comments regarding the chassis pool data.

10. The system of claim 6 wherein the analyses performed by said second means are based on chassis pool performance data, chassis maintenance and repair data, and chassis pool administration data.

11. The system of claim 10 wherein the analyses of chassis pool performance data comprise one or more of the following: inventory status, unit activity and history, units idle over x days (where x is a user-selectable value), units out over x days, units currently out of service, budgeted versus actual utilization summary, budgeted versus actual utilization daily, actual daily utilization, imbalance, turn time, and trips per unit per month.

12. The system of claim 10 wherein the analyses of chassis maintenance and repair data comprise one or both of: (i) maintenance and repair costs and (ii) units damaged and units returned to service.

13. The system of claim 10 wherein the analyses of chassis pool administration data comprise one or more of the following: billing summary reports, revenue distribution summary reports, operations expense and revenue summary reports, and licensing reports.

14. A computer-based data analysis system for managing a chassis pool, comprising:
(a) database server means for storing and processing chassis pool data;
(b) one or more user terminals for access to said database server by users of said system;
(c) application server means for communicating between said user terminals and said database server;
(d) first means for specifying an analysis to be performed, said first means comprising means for selecting a pre-defined analysis to be performed from among a list of pre-defined analyses and means for creating an analysis by selecting or entering the appropriate value for each relevant parameter from among a list of available parameters; and
(e) second means, responsive to said first means, for performing analyses of chassis pool data according to the criteria of the selected analysis, said second means comprising an expert system;
wherein the analyses performed by said second means are based on chassis pool performance data, chassis maintenance and repair data, and chassis pool administrative data.

15. A computer-based data analysis system for managing a pool of fungible items, comprising:
(a) a database server including a pool data storage system and a pool data processing system;
(b) one or more user terminals for access to said database server by users of said system, to which users can submit a requested pool analysis to be performed; and
(c) an application server providing communications between said user terminals and said database server;
said user terminals communicating said requested pool analysis to said application server, said application server obtaining pool data from said database server, performing said requested pool analysis based thereon, and communicating the results of said requested pool analysis to the user terminals.

16. The system of claim 15 wherein said user terminals permit users of the system to select the requested pool analysis from among a list of pre-defined pool analyses.

17. The system of claim 15 wherein said user terminals permit users to create a new pool analysis to be requested, by selecting or entering, from among a plurality of available parameters regarding pool operations, the appropriate value for each relevant pool parameter such that the requested pool analysis performed according to the selected or entered parameters will provide an analysis of the desired aspects of pool operations.

18. The system of claim 15 further comprising an expert system, said expert system applying pre-defined rules regarding pool operations to provide diagnostic comments regarding the results of the requested pool analysis.

19. The system of claim 15 wherein the requested pool analysis is based on pool performance data, maintenance and repair data, or pool administration data.

20. A computer-based data analysis system for managing a chassis pool, comprising:
(a) a database server including a chassis pool data storage system and a chassis pool data processing system;
(b) one or more user terminals for access to said database server by users of said system, to which users can submit a requested chassis pool analysis to be performed; and
(c) an application server providing communications between said user terminals and said database server;
said user terminals communicating said requested chassis pool analysis to said application server, said application server obtaining chassis pool data from said database server, performing said requested chassis pool analysis based thereon, and communicating the results of said requested chassis pool analysis to the user terminals.

21. The system of claim 20 wherein said user terminals permit users of the system to select the requested chassis pool analysis from among a list of pre-defined chassis pool analyses.

22. The system of claim 20 wherein said user terminals permit users to create a new chassis pool analysis to be requested, by selecting or entering, from among a plurality of available parameters regarding chassis pool operations, the appropriate value for each relevant chassis pool parameter such that the requested chassis pool analysis performed according to the selected or entered parameters will provide an analysis of the desired aspects of chassis pool operations.

23. The system of claim 20 further comprising an expert system, said expert system applying pre-defined rules regarding chassis pool operations to provide diagnostic comments regarding the results of the requested chassis pool analysis.

24. The system of claim 20 wherein the requested chassis pool analysis is based on chassis pool performance data, chassis maintenance and repair data, or chassis pool administration data.

25. The system of claim 24 wherein the analyses of chassis pool performance data comprise one or more of the following: inventory status, unit activity and history, units idle over x days (where x is a user-selectable value), units out over x days, units currently out of service, budgeted versus actual utilization summary, budgeted versus actual utilization daily, actual daily utilization, imbalance, turn time, and trips per unit per month.

26. The system of claim 24 wherein the analyses of chassis maintenance and repair data comprise one or both of: (i) maintenance and repair costs and (ii) units damaged and units returned to service.

27. The system of claim 24 wherein the analyses of chassis pool administration data comprise one or more of the following: billing summary reports, revenue distribution summary reports, operations expense and revenue summary reports, and licensing reports.

28. A computer-based data analysis system for managing chassis pool, comprising:
(a) a database server including a chassis pool data storage system and a chassis pool data processing system;
(b) one or more user terminals for access to said database server by users of said system, to which users can request a chassis pool analysis to be performed, by: (i) selecting the requested chassis pool analysis from among a list of pre-defined chassis pool analyses, or (ii) creating a new chassis pool analysis by selecting or entering, from among a plurality of available parameters regarding chassis pool operations, the appropriate value for each relevant chassis pool parameter such that the requested chassis pool analysis performed according to the selected or entered parameters will provide an analysis of the desired aspects of chassis pool operations;
(c) an expert system applying pre-defined rules regarding chassis pool operations to provide diagnostic comments regarding the results of the requested chassis pool analysis; and
(d) an application server providing communications between said user terminals and said database server;
said user terminals communicating the request to said application server, said application server communicating the request for a chassis pool analysis to said database server, said database server performing said requested chassis pool analysis and providing the results of said requested chassis pool analysis to said application server, which communicates said requested chassis pool analysis to the user terminals, wherein the requested chassis pool analysis is based on chassis pool performance data, chassis maintenance and repair data, or chassis pool administration data.

29. A computer-based data processing method for managing a pool of fungible items, comprising the steps of:
(a) processing input data regarding the items in the pool;
(b) storing the input data;
(c) accessing the input data with a database server;
(d) extracting and analyzing the input data according to analysis parameters specified by a user; and
(e) displaying the results of the analysis of the input data to the user.

30. The method of claim 29, wherein the step of extracting and analyzing the input data comprises applying an expert system to the input data, said expert system being provided with the analysis parameters and predefined pool operation rules, and wherein further the step of displaying the results comprises the presentation of the expert system's diagnostic comments to the user.

31. The method of claim 29, wherein the step of extracting and analyzing the input data further comprises the step of the user choosing to analyze input data relevant to one of the categories of: pool performance, maintenance and repair, or pool administration.

32. A computer-based data processing method for managing a chassis pool, comprising the steps of:
(a) processing input data regarding the chassis in the pool;
(b) storing the input data;
(c) accessing the input data with a database server;
(d) extracting and analyzing the input data according to analysis parameters specified by a user; and
(e) displaying the results of the analysis of the input data to the user.

33. The method of claim 32, wherein the step of extracting and analyzing the input data comprises applying an expert system to the input data according to the analysis parameters and predefined chassis pool operation rules, and wherein further the step of displaying the results comprises the presentation of the expert system's diagnostic comments to the user.

34. The method of claim 32, wherein the step of extracting and analyzing the input data further comprises the step of the user choosing to analyze input data relevant to one of the categories of: chassis pool performance, chassis maintenance and repair, or chassis pool administration.
